(19) United States
(12) Patent Application Publication
(10) Pub. No.: US 2025/0389151 A1
(43) Pub. Date: Dec. 25, 2025

(54) HISTORIC DIVIDED LITE WINDOW STRUCTURE

(71) Applicants: John C. Magri, JR., Stockton Springs, ME (US); Ralph J. McDermott, JR., Lincolnville, ME (US); Ryan H. Harnden, Belfast, ME (US); Kyle S. Hawthorne, Morrill, ME (US); Alex Hawthorne, Belfast, ME (US)

(72) Inventors: John C. Magri, JR., Stockton Springs, ME (US); Ralph J. McDermott, JR., Lincolnville, ME (US); Ryan H. Harnden, Belfast, ME (US); Kyle S. Hawthorne, Morrill, ME (US); Alex Hawthorne, Belfast, ME (US)

(21) Appl. No.: 19/063,145

(22) Filed: Feb. 25, 2025

Related U.S. Application Data
(60) Provisional application No. 63/663,785, filed on Jun. 25, 2024.

(51) Int. Cl. E06B 3/68; E06B 3/24; E06B 3/66

(52) U.S. Cl. CPC E06B 3/685; E06B 3/24; E06B 3/6621

(57) ABSTRACT

The invention pertains to hermetically sealed glass using vacuum technology to remove still air, preventing the infiltration and exfiltration of heat through the installed glass in a modern window and/or door system composed of vinyl, wood, or other readily available substrate, thereby minimizing the negative impact of heat loss through the outer edges of the hermetically sealed glass, while also applying lengths of hollow vinyl, solid wood, or other readily available substrates to the exposed portions of the hermetically sealed glass to give the appearance of a window/door utilizing multiple single pieces of glass.

### CROSS REFERENCE TO RELATED APPLICATION

This application claims the benefit of the provisional patent application, U.S. Ser. No. 63/663,785, filed Jun. 25, 2024, entitled “Historic Divided Lite Window Structure” (John C. Magri, Jr., et al.), and currently pending, which is hereby incorporated by reference.

### BACKGROUND OF THE INVENTION

Historically, the most common window products produced contained true divided lite (TDL) wood sashes or panels. The sash/panel is most often the operable or replaceable portion of a window or door system, as opposed to the frame, which is installed into the opening of a wall. TDL would be part of various configurations for different window or door types. TDL are the traditional, individual glass openings, sometimes referred to as panes, created from wooden sash members called bars and muntins. The (vertically oriented) bars and the (horizontally oriented) muntins would be assembled within a sash to create the individual openings that would then accept individual, singular lites of glass. (See FIG. 1.) Each lite of glass would be installed into the sash, typically with a glazing compound consisting of whiting (calcium carbonate) and linseed oil, although various other ingredients have been utilized over the years. Part of this process was to hand glaze, or in fenestration terms, “putty glaze,” the compound around the perimeter of each lite of glass on the exterior side of the window or door. The compound was applied at an angle along the glass and sash or muntin/bar edge to cover the edge of the glass. (See FIG. 2.)

Windows and doors with true divided lites have been used in buildings for generations as double hung (vertical slider), picture, casement, utility, skylight, and cellar windows as well as entry and interior doors. They aid in creating a distinctive and desired aesthetic for a building.

Windows and doors utilizing TDL can be traced back to before the Industrial Revolution when glass was produced with a blowpipe. A worker known as a glass blower would blow air into glass that had been softened by heating it. Only small, distorted pieces of glass could be created using this method. These techniques improved over time, but the quality of the glass was still very poor compared to today's standards, and the glass was very labor-intensive to produce. Although the quality was not perfect, many historic buildings still have this old handmade glass in their true divided lite windows to this day.

It was not until the 20 Jan. 1959 that the float glass process was first put into production by its inventor, Sir Alastair Pilkington. The float method of producing glass involves creating a ribbon of glass on top of a bath of molten tin. This creates a smooth surface without the additional processing time and labor that was required with earlier glass-producing methods. Since 1959, Pilkington Glass and many other companies have been using the float glass method to mass-produce higher quality glass in larger pieces than ever before.

With advancements in glass manufacturing, the limitations of producing sashes with small glass openings and single, thin panes of glass have been eliminated. Larger sheets of glass can be produced with relative ease, cut to almost any custom size, and used in a number of current standard glass configurations, including dual, triple, and even quad pane glazing. Despite gains in technology and a higher degree of energy efficiency, the demand and desire to replicate TDL windows and doors remain. Whether replacing existing windows to retain the aesthetics of a building or recreating the look in new buildings, the demand for a historically accurate product is prevalent in the market. Many existing TDL products are in historic districts or buildings with restrictions around replacing the existing windows and doors with products that don't fit the historic character of the building, neighborhood, or even town. On top of those restrictions, there is a desire, and in almost all cases, codes or laws, to improve the thermal efficiency of the building with an energy-efficient product. The challenge of meeting these two seemingly contradictory criteria is the driving force behind this invention.

The current accepted technology utilizes two, three, or four pieces of glass sealed with a spacer system along the perimeter of each piece of glass to make an insulating glass unit. This unit is often filled with an inert, noble gas (such as Argon or Krypton) to help reduce heat loss through the glass once installed in the window unit and ultimately the frame of the building. Due to the aforementioned regulations surrounding historic buildings, replacing single-paned glass with double, triple, or in some cases quadruple-paned replacement windows is not historically accurate. Leaving the single-paned glass installed is not acceptable for the total energy efficiency of the building envelope and leaves a deteriorating portion of the building in place due to the lack of a qualifying replacement.

Vacuum Insulated Glass, or VIG, is a commercially available insulating glass unit that utilizes vacuum technology to create an industry leading thermal performance option for the fenestration industry. A VIG panel is comprised of two layers of annealed, heat strengthened or tempered glass that are minimally separated, typically in the range of 0.1 mm to 0.3 mm. The vacuum removes most of the air from between the layers of glass minimizing heat transfer from one side of the VIG to the other. A typical VIG panel can have a center of glazing U-factor of 0.06 (equivalent to an “R-rating”—that is, the thermal resistance rating of a structure that is used as an efficiency standard in the construction industry, where the higher the rating the more thermally resistant the structure is—of R-17). This compares favorably to other standard center of glazing U-factors: dual pane insulating glass has a U-factor range of 0.50 to 0.25 (R-2 to R-4), and triple pane glass has a U-factor range of 0.30 to 0.15 (R-3.3 to R-6.6).

The exterior glass layer typically has a low-e (low emissivity) coating on the inner surface of the glass that faces the interior glass layer. This low-e coating, along with the vacuum space between the glass layers, provides a thermally superior glass option. It does this by significantly reducing heat transfer through the fenestration product and thereby improving the energy efficiency of the building where the products is installed.

The edge of the glass is sealed with a thin rigid spacer, often metallic, that maintains the structure of the edge of the glass. Along with the edge seal, an array of pillars is placed in between the glass that act as supports of the glass layers so that the vacuum space is maintained. The pillars are made from various materials including ceramics, stainless steel or other structurally strong materials. Since the pillars are visible when looking through the VIG panel, they are relatively small at 1 mm or less in diameter. The pillars are uniformly spaced based on overall glass area and glass thickness. The pillar size, pillar locations, and pillar spacing are manufacturer specific and are not directly part of the described invention.

While VIG is commercially available technology today, there are numerous current challenges with using VIG. One such challenge is that, in a departure from the current technology where two or more pieces of glass are separated by a spacer system using butyl, silicone, and/or other materials designed to create a warm perimeter around the glass, VIG uses thin layers of material, often metallic, to aid in maintaining the vacuum between the two layers of glass. While the VIG has superior center of glass thermal performance due to the vacuum effect, the conductive materials used as the spacer between the glass layers ensures that there is a significant area of the perimeter of the glass that creates a cold edge. This metallic or glass edge drastically reduces the whole unit's energy performance, partially negating the significant gains that the center of the glass makes over the current technology. While the technology produces a thermal result that is superior in almost all cases to any modern Insulating Glass Unit of any widely accepted and feasible design, it cannot currently be maximized due to VIG's limiting perimeter edge performance.

Another problem is that modern window and door systems are not designed with the past in mind. They do not take into account the historic market. Windows and doors are designed for performance and often sacrifice aesthetics from a historic perspective.

A major challenge currently is that many historically significant buildings are being used to house underprivileged, underserved, or historically marginalized communities where financial resources are limiting factors. The current options to restore buildings to their historic base while preserving energy used to heat and cool these buildings are more often than not cost-prohibitive.

It is therefore an objective of the present invention is to preserve historical aesthetics of fenestration products in order to comply with federal, state, and local laws, regulations, and ordinances that strictly prohibit alterations compromising the historic accuracy of structures from their original time periods. Amid the push for energy efficiency and structural performance, there is significant demand for modern windows and doors that are both historically accurate and highly efficient.

It is another objective of the present invention to provide a product that combines modern energy efficiency technology with historically accurate aesthetics. The product maintains critical design elements while simultaneously improving the energy efficiency and structural performance of rapidly deteriorating single-glazed windows and/or doors that still remain in historic buildings. The product preserves the essential elements of the façade and the critical design features of the building. At present, no other products successfully combine both aspects.

It is yet another objective of the present invention to provide a complete line of windows that utilize Vacuum Insulating Glass while simultaneously minimizing the edge effect that reduces the whole window's performance.

It is yet another objective of the present invention to provide a line of doors that utilize Vacuum Insulating Glass while simultaneously minimizing the edge effect that reduces the whole door's performance.

It is yet another objective of the present invention to manufacture systems that will give a true replicated historically accurate visual appearance to fenestration products currently installed in historically significant buildings.

It is yet another objective of the present invention to produce a product that utilizes “Historic Divided Lites,” which will offer a solution to the relatively inaccurate simulated divided lite (SDL) (see FIGS. 3 and 4) currently utilized on retrofit products that do not closely resemble products using single glazing enough to qualify for historically significant buildings.

It is yet another objective of the present invention to provide a reasonable option for underprivileged, underserved, and historically marginalized communities to have access to historically accurate, high-performance windows to help further save on energy costs, by providing windows which are eligible for both energy efficiency grants due to their performance and grants to assist in rehabilitating buildings to serve marginalized communities. Historically, these two objectives have been incompatible, as buildings were either historic but not energy-efficient or energy-efficient but not historic.

It is yet another objective of the present invention to use durable materials that will allow windows to have a significant lifespan, as opposed to manufacturers using new-growth wood that lacks inherent strength and will have a much shorter lifespan than the materials of the present invention.

Various other objectives and advantages will become apparent with the description of the invention.

### SUMMARY OF THE INVENTION

Historically, a window assembly was constructed of one or more panes of glass fitted into a rectangular wooden structure, called a sash, and then the sash was fitted into a wooden frame that attached the window assembly to the building. The left and right sides of the sash were known as stiles, the top of the sash was known as the top rail, and the bottom of the sash was known as the bottom rail. In more modern times, a window assembly is often constructed of one or more panes of glass fitted directly into a frame (not necessarily made of wood) that attaches the window assembly to the building (in other words, the sash is not used). The left and right sides of the frame are known as jambs, the top of the frame is known as the head, and the bottom of the frame is known as the sill. Modern windows may also have the sash-plus-frame configuration.

In order to properly describe the present invention, a standard terminology will be used herein.

As used herein, the terms “window frame” or “door frame” are defined to mean either the combination of a sash and frame, or just the frame (depending on the style of window frame or door frame at issue).

The term “left vertical member” of the window or door frame is defined to mean the left stile of the sash or the left jamb of the frame (depending on the style of window or door frame at issue).

The term “right vertical member” of the window or door frame is defined to mean the right stile of the sash or the right jamb of the frame (depending on the style of window or door frame at issue).

The term “top horizontal member” of the window or door frame is defined to mean the top rail of the sash or the head of the frame (depending on the style of window or door frame at issue).

The term “bottom horizontal member” of the window or door frame is defined to mean the bottom rail of the sash or the sill of the frame (depending on the style of window or door frame at issue).

The term “VIG panel” is defined to mean a vacuum insulated glass assembly comprised of multiple layers of glass with a vacuum between each adjacent pair of layers of glass, capable of being fitted into a window or door frame.

The term “perimeter edge” of the VIG panel is defined to mean the area of the VIG panel extending inward from the edge of the VIG panel towards the center of the VIG panel, typically having a uniform width of ½ inch.

The term “daylight opening” is defined to mean the portion of the VIG panel that spans the region between the left and right vertical members and the top and bottom horizontal members.

The term “muntin” is defined to be a part or an assembly that is placed onto a VIG panel. A muntin typically comprises one or more vertically oriented members and one or more horizontally oriented members, with the each vertically oriented member adjacent to at least one horizontally oriented member, and each horizontally oriented member adjacent to at least one vertically oriented member. This term as used herein is intended to capture the concept of a combination of a vertical bar and horizontal muntin as those components were used in the historical context of a true divided lite window. In some embodiments, there may be only one or more vertically oriented muntins, and in other embodiments there may be only one or more horizontally oriented muntins.

The term “interior muntin” is defined to be a muntin that is placed onto the interior surface of a VIG panel (that is, a surface of the VIG panel that faces the interior of the structure into which the window or door frame is fitted).

The term “exterior muntin” is defined to be a muntin that is placed onto the exterior surface of a VIG panel (that is, a surface of the VIG panel that faces the exterior of the structure into which the window or door frame is fitted).

The term “glazing pocket” is defined to be a cavity formed within a left vertical member, right vertical member, top horizontal member, or bottom horizontal member of the window or door frame that is configured to contain at least a portion of the perimeter edge of the VIG panel.

The aforementioned objectives and others are achieved by the following:

The present invention comprises a window or door frame utilizing manufactured multiple chambered muntins of various lengths and shapes using commercially available material such as but not limited to extruded plastics, compounds of plastics or metals or pultruded fiberglass or other stranded fiber substrate. The invention allows the perimeter of the VIG panel described above to sit within the window or door frame to a depth of approximately 2½ inches, such that the perimeter of the VIG panel that has a natural tendency (due to the technology of the VIG described previously) to have a higher heat/cold loss than anywhere else in the unit is encased within the insulating components of the window or door frame. By creating a location for the VIG to be placed within the window or door frame to a depth that is significantly greater than industry standards for other types of hermetically sealed glass units, the present invention effectively neutralizes the cold edge effect, therefore providing a superior whole unit performance value. (See FIG. 5.) By comparison, industry standards for locating other hermetically sealed glass units within a window or door frame is at a depth of ¼ inch to ¾ inch from the daylight opening edge of the window or door frame.

The present invention further uses strategically placed air cavities with naturally insulating properties in areas of the frame profiles where the VIG panel edge is more susceptible to heat infiltration/exfiltration or cold infiltration/exfiltration, thereby mitigating heat loss in cold climates and mitigating cold loss in warm climates.

To achieve historically accurate aesthetics, the present invention uses a feature described herein as “Historic Divided Lites” (HDL), which gives the exact visual representation of historic divided lite windows while utilizing a single pane of glass. The HDL has two separate components, or muntins: an interior muntin and an exterior muntin, together designed to have the appearance of historic muntins that have had glazing putty applied. Each length of HDL muntin will be machined at each end in such a way as to fit to the surrounding window or door frame to replicate the fit and joining method of the original TDL components and muntins.

The above-described muntins are historically accurate in terms of dimensions and aesthetic design to window and door frames produced in the 19th and 20th centuries. (See FIG. 6.) In one aspect, the muntins that hold the glass contain a distinctive profile to the interior. From the interior window or door frame surface, the muntin is known by its straight edge that is perpendicular to the glass surface, followed by a convex radius, followed by a concave radius, followed by a second straight edge that is perpendicular to the glass surface and ends at or near the glass surface. This interior muntin was widely used and desired in the historical time frame described herein. This muntin is used on the edge of a window or door frame that forms the perimeter of the daylight opening of the glass. This same muntin design is used on two opposing sides of the interior Historic Divided Lite muntin that are perpendicular to the glass surface. The interior HDL muntin is applied to the VIG surface to complete the interior portion of the Historic Divided Lite option. Depending on the desired aesthetics and the time period being matched, the width of the muntin ranges from ½ inch to 2¼ inches.

The angled surface of the exterior muntin was created from the application of putty glazing used to seal the glass and complete the window or door frame. The edge of the putty glazing that met the glass surface would align with the edges of the daylight opening from the interior of the window or door frame. This exterior detail is replicated in the present invention as part of the window or door frame profile that forms the perimeter of the daylight opening to the glass. The exterior detail is also replicated as part of the HDL muntin by combining the flat surface of the divider muntin with the glazing putty profile into a single trapezoidal profile where the angled surface is mirrored to each side of the horizontal surface. This HDL muntin profile width ranges from ½ inch to 2¼ inches so that it aligns with the interior muntin profiles once it is applied to the exterior glass surface.

In other aspects of the invention, additional manufactured muntin profiles are produced using commercially available material that is shaped in such a manner that reflects historical accuracy in size and design, to be used as Historic Divided Lites.

Affixing the HDL muntins to the VIG panel involves applying a VHB (Very High Bond) double sided tape product to the underside of each HDL profile, and adhering it to the outside surface of the VIG panel. VHB is a double-sided foam tape made from an acrylic polymer, suitable for bonding dissimilar substrates to each other, such as metal to plastic, or PVC to glass. VHB tape is pressure sensitive, building strength over time, and is highly resistant to environmental factors including heat, moisture, and ultraviolet light. The HDL muntins of the interior and the exterior surfaces of the VIG panel are placed in a manner that the daylight edges of both the interior and exterior muntins align with each other, creating the historically accurate TDL aesthetic. The Historic Divided Lites create an illusion of a true divided lite, as it will appear to the naked eye that the applied Historic Divided Lites from the exterior and interior are one muntin and is indistinguishable from a putty-glazed window or door frame utilizing individual single panes of glass. This effect is achieved because of the negligible airspace in the VIG panel (the current standard airspace in traditional insulated glass units is between ¼″ to ¾″ between the panes of glass, compared to a VIG panel having a 0.006″ to 0.012″ airspace between the panes of glass), together with the dark color of the VHB tape that is adhered to the underside of each muntin. The resultant shadow effect provides the illusion that the two individual muntins are actually one continuous element.

To maximize energy efficiency, the present invention creates a pocket in a multiple chambered window or door frame within which the perimeter of the VIG panel rests. The window or door frame is extruded, pultruded, or shaped out of standard materials including but not limited to Polyvinyl Chloride or other plastics or plastic compounds, fiberglass, and/or metals. An additional segment of multiple chambered material is added to aid in securing the glazing system to the window or door frame. The window system may contain design elements that have been of previously patented (U.S. Pat. Nos. 872,890S1, 907,251S1, 907,250S1, 888,996S1,872,891S1). The window system also contains readily available polystyrene, or other insulating materials, which is inserted into the multiple chambered window segments for the purpose of thermal improvement.

The present invention uses the natural insulating properties of still air cavities in chambered material as well as insulation to neutralize the natural conductive properties of the edges of the VIG panel to transfer heat through the fenestration opening in an otherwise insulating structure. Insulation thus may be as simple as creating air cavities near or around the glazing pockets. Alternatively, thermal insulation material such as polyurethane foam or polystyrene foam may be inserted into the air cavities. Typically, whatever type of insulation is used, the insulation is strategically placed in selected air cavities in order to give the best improvement in thermal performance.

The heat conductivity of VIG installed in a traditional or industry-standard sash or frame design offers an opportunity for conductive heat or cold transfer into or out of the building. With the recession of the perimeter of the glass into the glazing pockets, the edge effect of VIG is minimized, which maximizes the center of glass thermal performance, estimated at an R-17, within the range of minimum performance of wall thermal performance in the United States' coldest zones. By mitigating the edge effect, the Edge R Value of the VIG is maximized.

The thermal performance of fenestration products is based on several component areas. These include center-of-glazing area, edge-of-glazing area, divider area, edge-of-divider, frame area, and projected fenestration product area. Specifically, Center-of-glazing area (A_{c}) is a function of the glass, in this case, the VIG. The center-of-glazing area is the total daylight opening area of the glass less a 2.5″ perimeter called edge-of-glazing area. Edge-of-glazing area (Aₑ) is a 2.5″ perimeter from the daylight edge of the glass at the edge of the sash or frame that extends toward the center-of-glazing area. This is a static value regardless of product design and is set by ANSI/NFRC 100 Procedure for Determining Fenestration Product U-factors, an industry standard for simulating thermal performance of fenestration products. The divider area (A_{d}) is the area consumed by certain types of dividers that are placed in the airspace of a standard hermetically sealed glass unit. These dividers are often metallic and can adversely affect the thermal performance of the glass and the window or door. VIG panels by nature do not have the option of the divider. The frame area (A_{f}) is the calculated area based on the height of the window or door frame from the outer edge of the window or door frame to the inner edge of the window or door frame, known as the daylight opening edge or the edge-of-glazing area. The frame area is calculated by multiplying this height value against the width and height of the fenestration product. The projected area (A_{pf}) is the total area of the fenestration product when multiplying the overall width by the overall height of the window or door.

The total product rating (Ut) is calculated by the following formula:

$${U}_{t} = [ \sum ( {U}_{f} {A}_{f} ) + \sum ( {U}_{d} {A}_{d} ) + \sum ( {U}_{e} {A}_{e} ) + \sum ( {U}_{de} {A}_{de} ) + \sum ( {U}_{c} {A}_{c} ) ] / {A}_{pf}$$

$$where :$$

$${U}_{t} = Total Product U - factor$$

$${A}_{pf} = Projected fenestration product area$$

$${U}_{f} = Frame U - factor$$

$${A}_{f} = Frame Area$$

$${U}_{d} = Divider U - factor$$

$${A}_{d} = Divider Area$$

$${U}_{e} = Edge - of - glazing U - factor$$

$${A}_{e} = Edge - of - glazing area$$

$${U}_{de} = Edge - of - divider U - factor$$

$${A}_{de} = Edge - of - divider area$$

$${U}_{c} = Center - of - glazing U - factor$$

$${A}_{c} = Center - of - glazing area$$

### Reference ANSI/NFRC 100 Procedure for Determining Fenestration Product U-factors

This formula illustrates the importance of maximizing the strengths of the fenestration product while minimizing the limiting factors. The strength of VIG is its industry leading center-of-glazing thermal performance, while its limiting factor is its edge-of-glazing thermal performance due to the conductive edge materials. As described, one of the keys to the present invention is minimizing the effect of VIG edge-of-glazing by creating profiles that allow the VIG to be located at a much greater depth in the fenestration system than the current industry standards. By locating the VIG deeper, the thermal performance of the whole product improves through the improved edge-of-glazing values.

The present invention is configured to be certifiable and authenticated under FGIA¹, ASTM², NFRC³ and other standards and procedures, and to comply with all local, state and federal building codes for structural and thermal performance.

The present invention can be produced in large quantities in short periods of time by using modern manufacturing methodology which lowers overhead costs as opposed to the current practice of traditionally manufacturing wood windows, which requires a significant time investment and highly manual processes.

The present invention can be used in both historic and modern applications interchangeably. ¹FGIA: Fenestration & Glazing Industry Alliance. This alliance is a combination of AAMA and IGMA. The American Architectural Manufacturers Association (AAMA) served as the source of performance standards, product certification and educational programs for the fenestration industry. Founded in 1936, AAMA was the leading trade association representing over 300 members producing window, door, skylight, sloped glazing, curtain wall and storefront products and components for both the residential and commercial construction markets across North America. The Insulating Glass Manufacturers Alliance (IGMA) was the North American association of insulating glass manufacturers, suppliers of component materials and other industry-related professionals dedicated to upgrading product performance by promoting awareness of technological developments in the industry. In 2000, IGMA was created as a result of a successful merger between the Insulating Glass Manufacturers Association of Canada (IGMAC) and the Sealed Insulating Glass Manufacturers Association (SIGMA).²ASTM: The American Society for Testing and Materials. Several ASTM standards are used in the testing and validation of fenestration products. These standards include, but are not limited to testing criteria for air, water, and structural ratings to be conducted by third party laboratories for product certification.³NFRC: National Fenestration Rating Council. NFRC sets the rules by which manufacturers can rate and label products with values such as u-factor, solar heat gains, visible light transmittance, and air leakage. NFRC's role includes monitoring and certifying independent laboratories to perform third party testing and simulations for manufacturers, monitoring and certifying inspection agencies, and maintaining databases of the product ratings for manufacturers.

It is to be understood that the foregoing and following description of the invention is intended to be illustrative and exemplary rather than restrictive of the invention as claimed. These and other aspects, advantages, and features of the invention will become apparent to those skilled in the art after review of the entire specification, accompanying figures, and claims.

### DESCRIPTION OF THE DRAWINGS

FIG. 1 depicts a historical prior art window structure, having true divided lites fitted within a sash, separated by a vertical bar and a pair of horizontal muntins.

FIG. 2 is a top cutaway view of the prior art window structure of FIG. 1, depicting the vertical bar in cross-section relative to the two individual lites of glass secured on either side. Also shown is the putty compound around the perimeter of each lite of glass on the exterior side of the window, applied at an angle along the glass and sash or muntin/bar edge to cover the edge of the glass.

FIG. 3 is a perspective view of a contemporary prior art window structure having a single lite of double paned glass and simulated bars and muntins.

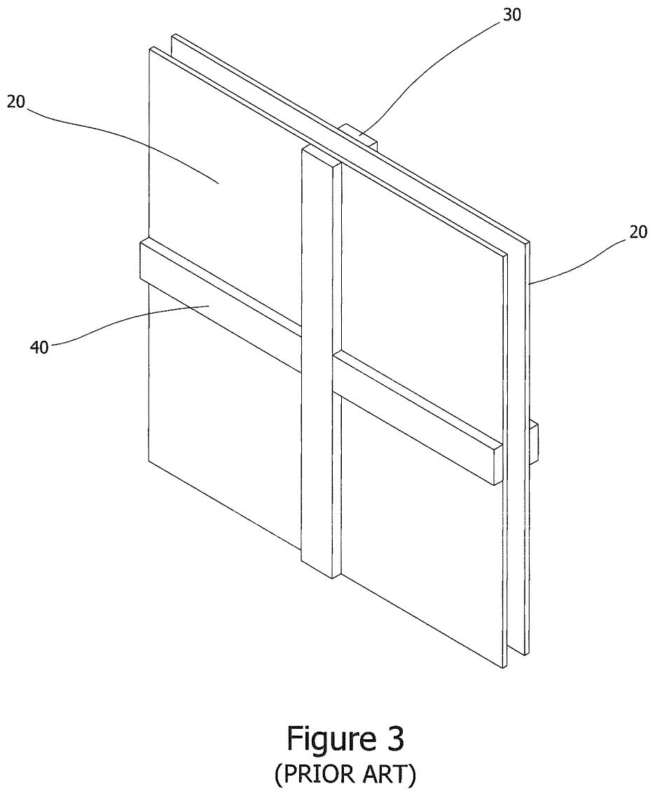

FIG. 4 is a cutaway top view of the prior art window structure of FIG. 3.

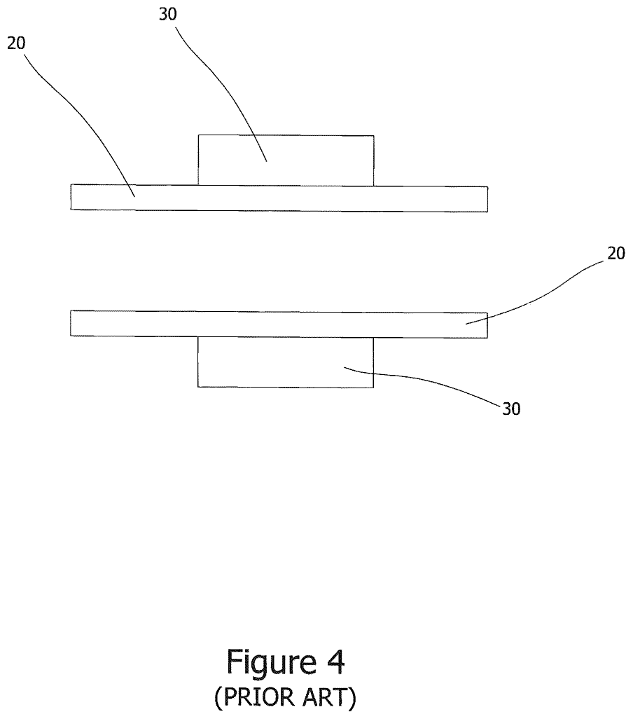

FIG. 5 is a side cutaway view of one embodiment of the present invention, showing the VIG panel inserted into the bottom horizontal member of the window frame, wherein a glazing pocket formed into the bottom horizontal member of the window frame receives the bottom of the perimeter edge of the VIG panel.

FIG. 6 is a cutaway top view of another embodiment of the present invention, showing the exterior muntin and the interior muntin as affixed to the VIG panel.

FIG. 7 depicts one embodiment of the invention, whereby the VIG panel fits within the window frame.

FIG. 8 depicts another embodiment of the invention, whereby the perimeter edge of the VIG panel is embedded into the window frame 2 to 2½ inches beyond the daylight opening, with the muntins affixed to the surface of the daylight opening of the VIG panel.

FIG. 9 depicts another embodiment of the invention, showing the VIG panel in cutaway cross section with its bottom perimeter edge fit into the glazing pocket of the bottom horizontal member of the window frame.

### DETAILED DESCRIPTION OF THE INVENTION

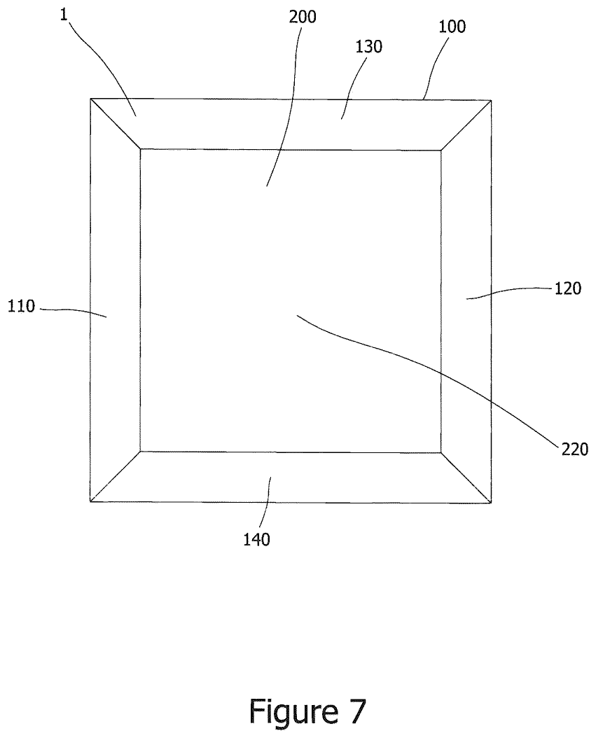

One embodiment of the present invention is a window structure 1 comprising a window frame 100 and a vacuum insulated glass (VIG) panel 200. (See FIG. 7.) The window structure 1 may be used as a window fitted into the wall of a building. In the same manner, the window structure can be fit to a door frame. The window frame 100 is substantially rectangular. The VIG panel 200 is comprised of vacuum insulated glass, is substantially rectangular, and has a perimeter edge 210 comprised of a left edge 212, right edge 214, top edge 216, and bottom edge 218. The VIG panel 200 is dimensioned to fit within the window frame 100. When the VIG panel 200 is inserted into the window frame 100 and sealed thereto, the portion of the VIG panel 200 that is bounded by the window frame 100 is known as the daylight opening 220 of the VIG panel 200. The daylight opening 220. It is contemplated that the rectangular shape of the window frame 100 may have a longer vertical dimension than its horizontal dimension, or may have a longer horizontal dimension than its vertical dimension, or it may be a square, with its vertical and horizontal dimensions being substantially the same.

In the preferred embodiment, the window frame 100 is comprised of a left vertical member 110, a right vertical member 120, a top horizontal member 130, and a bottom horizontal member 140. (See FIG. 7.) In this embodiment, the daylight opening 220 of the VIG panel 200 is that portion of the VIG panel 200 bounded by the left vertical member 110, the right vertical member 120, the top horizontal member 130, and the bottom horizontal member 140 of the window frame 100. Each of the left vertical member 110, the right vertical member 120, the top horizontal member 130, and the bottom horizontal member 140 of the window frame 100 may be constructed of extruded plastics, such as polyvinyl chloride, other plastics, compounds of plastics or metals, or pultruded fiberglass or other stranded fiber substrate. Each of the left vertical member 110, the right vertical member 120, the top horizontal member 130, and the bottom horizontal member 140 of the window frame 100 may be shaped to provide an aesthetically pleasing interior surface and an aesthetically pleasing exterior surface, with the preferred embodiments having the shaping of these elements mimic those of historical fenestration products. When the window frame 100 is so shaped, the window structure 1 of the present invention may be used as a replacement fenestration product for historical buildings.

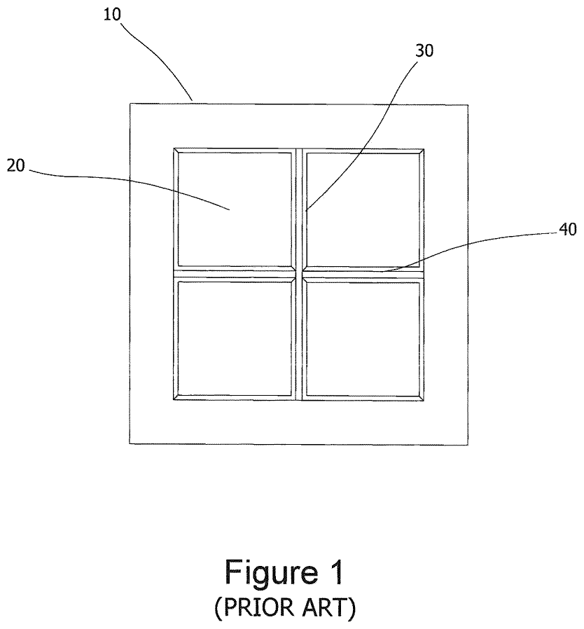

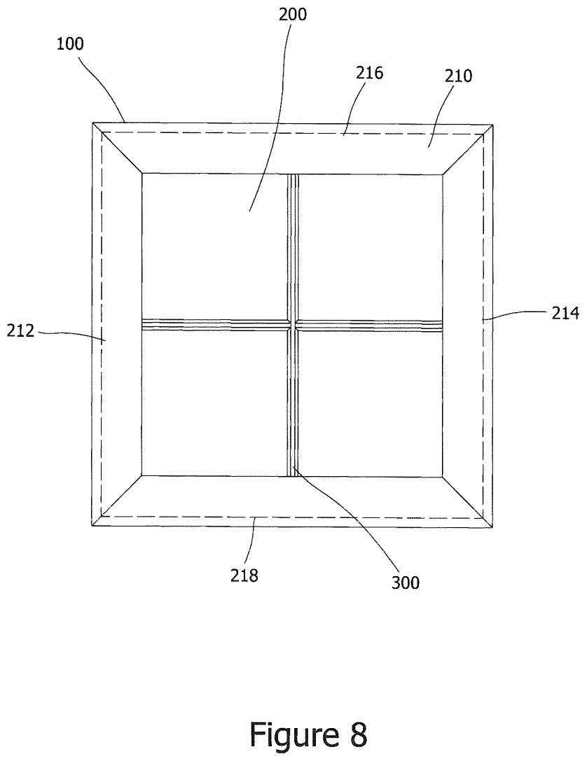

In one embodiment of the present invention, the window structure 1 further comprises an interior muntin 300 and an exterior muntin 400. The interior muntin 300 is comprised of one or more vertically oriented members and one or more horizontally oriented members. Each vertically oriented member of the interior muntin 300 intersects at least one horizontally oriented member of the interior muntin 300, and each horizontally oriented member of the interior muntin 300 intersects at least one vertically oriented member of the interior muntin 300. (See FIG. 8.) In alternative embodiments, the interior muntin 300 may be comprised of one or more vertically oriented members, but no horizontally oriented members, or the interior muntin 300 may be comprised of one or more horizontally oriented members, but no vertically oriented members; in these embodiments, the individual muntin members do not intersect with each other. The interior muntin 300 is dimensioned to fit onto the daylight opening 220 of the VIG panel 200. The grid-like structure of the interior muntin 300 mimics the “true divided lite” configuration found in historical fenestration products, where a muntin 30,40 formed the framework for each individual pane of glass 20 (a “lite”) that comprised the window. (See FIG. 1.) In the present invention, the interior muntin 300 overlays the entire daylight opening 220 of the VIG panel 200; thus, there is only one “true” lite, but the interior muntin 300 gives the appearance of multiple lites (FIG. 8 shows a window mimicking a “four lite” window). The exterior muntin 400 of the window structure 1 is configured similarly as the interior muntin 300. It is likewise dimensioned to fit onto the daylight opening 220 of the VIG panel 200. The interior muntin 300 is affixed to the interior surface 222 of the daylight opening 220 of the VIG panel 200, and the exterior muntin 400 is affixed to the exterior surface 224 of the daylight opening 220 of the VIG panel 200, such that the interior muntin 300 and the exterior muntin 400 are aligned with each other on either side of the VIG panel 200. In the most preferred embodiment, the interior muntin 300 is affixed to an interior surface 222 of the daylight opening 220 of the VIG panel 200 by the use of very high bond double sided tape 510. Likewise, the exterior muntin 400 is affixed to an exterior surface 224 of the daylight opening 220 of the VIG panel 200 by the use of very high bond double sided tape 510.

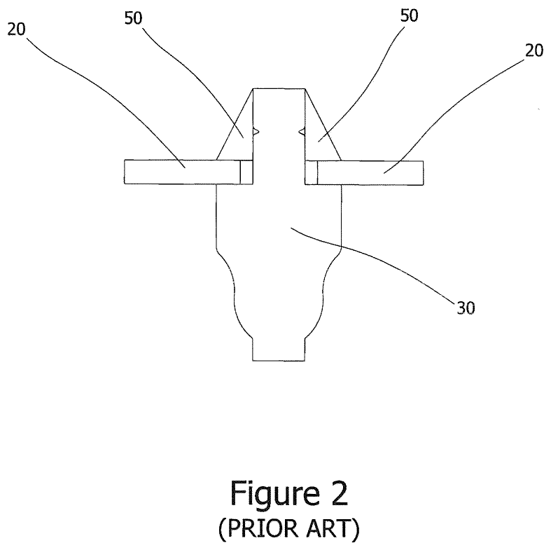

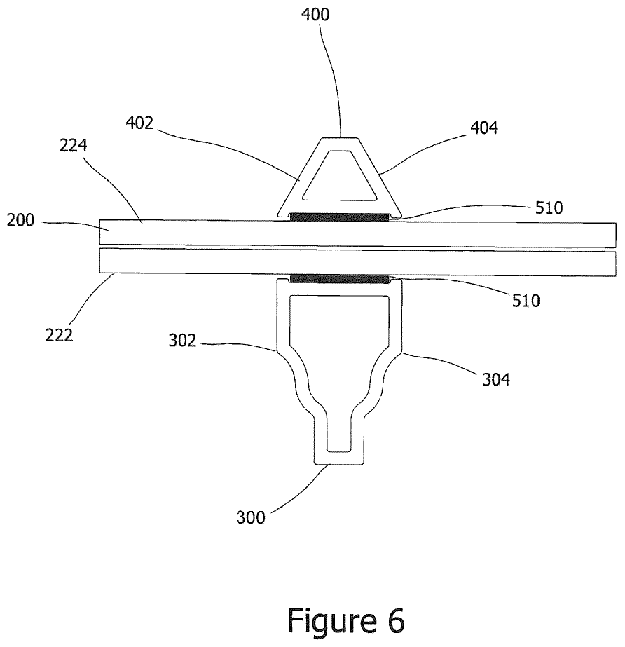

When affixed to the VIG panel 200, the interior muntin 300 extends inward from the interior surface 222 of the daylight opening 220 of the VIG panel 200 in a substantially perpendicular orientation thereto. The exterior muntin 400 extends outward from the exterior surface 224 of the daylight opening 220 of the VIG panel 200 in a substantially perpendicular orientation thereto. The width of the interior muntin 300 is substantially the same as the width of the exterior muntin 400. In the preferred embodiments, the widths of the interior muntin 300 and the exterior muntin 400 range from ½ inch to 2¼ inches. The interior muntin 300 has a first lateral side 302 and a second lateral side 304. In one embodiment, the first lateral side 302 of the interior muntin 300 is shaped by a series of straight lines and curves, mimicking the design of historical muntins 30. (See FIGS. 2 and 6.) The second lateral side 304 of the interior muntin 300 is similarly shaped, but in mirror image of the first lateral side 302 of the interior muntin 300. The first lateral side 402 of the exterior muntin 400 is typically planar, rather than curved, and is oriented substantially perpendicular to the exterior surface 224 of the daylight opening 220 of the VIG panel 200. The second lateral side 404 of the exterior muntin 400 is similarly shaped and oriented. Again, this design is intended to mimic historical muntins 30. Notwithstanding the foregoing, other embodiments of the present invention will have interior muntins 300 and exterior muntins 400 with different shapes, including embodiments where the interior muntin 300 and the exterior muntin 400 have identical shapes, where the interior muntin 300 is substantially planar, and where the exterior muntin 400 is curved, among other designs.

In the most preferred embodiment of the present invention, the exterior muntin 400 mimics the aesthetic of the glazing putty 50 used to secure the individual panes of glass 20 within the muntins 30 of historical fenestration products. This effect is achieved by the first lateral side 402 of the exterior muntin 400 being sloped from the exterior muntin 400 to the exterior surface 224 of the daylight opening 220 of the VIG panel 200, and the second lateral side 404 of the exterior muntin 400 being sloped from the exterior muntin 400 to the exterior surface 224 of the daylight opening 220 of the VIG panel 200. (See FIG. 6.) The use of sloped lateral sides 402,404 of the exterior muntin 400 mimics the aesthetic of glazing putty 50 used to secure the individual panes of glass 20 within the muntins 30 of historical fenestration products. (See FIG. 2.)

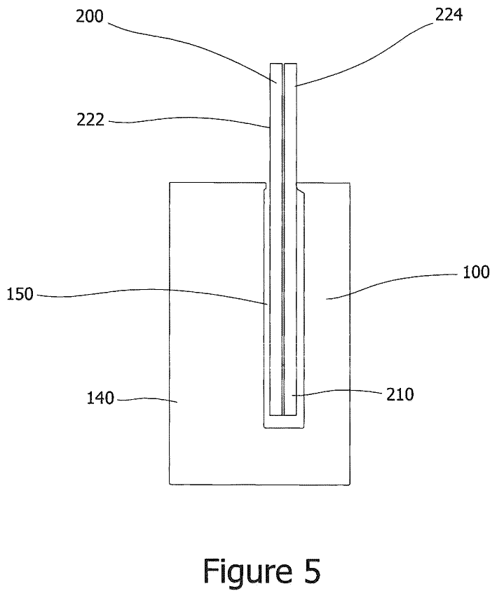

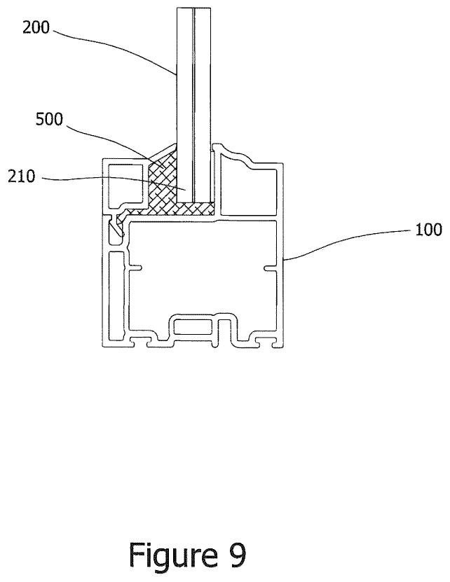

In another embodiment of the present invention, each of the left vertical member 110 of the window frame 100, the right vertical member 120 of the window frame 100, the top horizontal member 130 of the window frame 100, and the bottom horizontal member 140 of the window frame 100 comprises a glazing pocket 150. Each glazing pocket 150 is an aperture running from the inner edge of the member into the interior of the member at a uniform depth. (See FIG. 5.) In this embodiment, the left edge 212 of the perimeter edge 210 of the VIG panel 200 is dimensioned to be fully inserted into the glazing pocket 150 of the left vertical member 110 of the window frame 100, the right edge 214 of the perimeter edge 210 of the VIG panel 200 is dimensioned to be fully inserted into the glazing pocket 150 of the right vertical member 120 of the window frame 110, the top edge 216 of the perimeter edge 210 of the VIG panel 200 is dimensioned to be fully inserted into the glazing pocket 150 of the top horizontal member 130 of the window frame 100, and the bottom edge 218 of the perimeter edge 210 of the VIG panel 200 is dimensioned to be fully inserted into the glazing pocket 150 of the bottom horizontal member 140 of the window frame 110. (See FIG. 8.) By embedding the perimeter edge 210 of the VIG panel 200 within the members of the window frame, the amount of heat energy that can be transferred through the perimeter edge 210 of the VIG panel 200 is minimized. In the preferred embodiment of this configuration, the depth of each glazing pocket 150 is between 2 inches and 3 inches; in the most preferred embodiment, the depth of each glazing pocket 150 is 2½ inches. Moreover, each glazing pocket 150 may comprise a thermally insulating material 500. (See FIG. 9.) The thermally insulating material 500 may be a polyurethane foam, a polystyrene foam, or other insulating material known in the art. Even trapped air sealed within the glazing pockets 150 can act as an insulator to minimize the transfer of heat energy through the perimeter edge 210 of the VIG panel 200.

While the preferred embodiments of the present invention have been described, modifications can be made and other embodiments may be devised without departing from the spirit of the invention.

I claim:

1. A window structure comprising
a window frame, and
a VIG panel,
wherein the window frame is substantially rectangular, and
the VIG panel is comprised of vacuum insulated glass, is substantially rectangular, has a perimeter edge comprised of a left edge, right edge, top edge, and bottom edge, and is dimensioned to fit within the window frame;
whereby the VIG panel is inserted into the window frame and sealed thereto, thereby forming a daylight opening of the VIG panel, said daylight opening being a portion of the VIG panel bounded by the window frame.

2. The window structure of claim 1 wherein
the window frame is comprised of a left vertical member, a right vertical member, a top horizontal member, and a bottom horizontal member;
whereby the daylight opening of the VIG panel is bounded by the left vertical member, the right vertical member, the top horizontal member, and the bottom horizontal member of the window frame.

3. The window structure of claim 2 further comprising
an interior muntin, and
an exterior muntin;
wherein the interior muntin is dimensioned to fit onto the daylight opening of the VIG panel, and
the exterior muntin is dimensioned to fit onto the daylight opening of the VIG panel;
whereby the interior muntin is affixed to an interior surface of the daylight opening of the VIG panel, and
the exterior muntin is affixed to an exterior surface of the daylight opening of the VIG panel.

4. The window structure of claim 3 wherein
the interior muntin is comprised of one or more vertically oriented members and one or more horizontally oriented members, with each vertically oriented member of the interior muntin intersecting at least one horizontally oriented member of the interior muntin, and with each horizontally oriented member of the interior muntin intersecting at least one vertically oriented member of the interior muntin, and
the exterior muntin is comprised of one or more vertically oriented members and one or more horizontally oriented members, with each vertically oriented member of the exterior muntin intersecting at least one horizontally oriented member of the exterior muntin, and with each horizontally oriented member of the exterior muntin intersecting at least one vertically oriented member of the exterior muntin.

5. The window structure of claim 3 wherein
the interior muntin is comprised of one or more vertically oriented members, and
the exterior muntin is comprised of one or more vertically oriented members.

6. The window structure of claim 3 wherein
the interior muntin is comprised of one or more horizontally oriented members, and
the exterior muntin is comprised of one or more horizontally oriented members.

7. The window structure of claim 3 wherein
the interior muntin extends inward from the interior surface of the daylight opening of the VIG panel in a substantially perpendicular orientation thereto, and
the exterior muntin extends outward from the exterior surface of the daylight opening of the VIG panel in a substantially perpendicular orientation thereto.

8. The window structure of claim 7 wherein
the interior muntin has a width and the exterior muntin has a width, with the width of the interior muntin being substantially the same as the width of the exterior muntin.

9. The window structure of claim 8 wherein
the width of the interior muntin ranges from ½ inch to 2¼ inches, and
the width of the exterior muntin ranges from ½ inch to 2¼ inches.

10. The window structure of claim 7 wherein
the interior muntin has a first lateral side and a second lateral side, and
the exterior muntin has a first lateral side and a second lateral side,
with the first lateral side of the interior muntin being shaped by a series of straight lines and curves,
the second lateral side of the interior muntin being shaped by a series of straight lines and curves in a mirror image design of the first lateral side of the interior muntin,
the first lateral side of the exterior muntin being substantially planar and oriented substantially perpendicular to the exterior surface of the daylight opening of the VIG panel, and
the second lateral side of the exterior muntin being substantially planar and oriented substantially perpendicular to the exterior surface of the daylight opening of the VIG panel.

11. The window structure of claim 7 wherein
the interior muntin has a first lateral side and a second lateral side, and
the exterior muntin has a first lateral side and a second lateral side,
with the first lateral side of the interior muntin being shaped by a series of straight lines and curves,
the second lateral side of the interior muntin being shaped by a series of straight lines and curves in a mirror image design of the first lateral side of the interior muntin,
the first lateral side of the exterior muntin is sloped from the exterior muntin to the exterior surface of the daylight opening of the VIG panel, and
the second lateral side of the exterior muntin is sloped from the exterior muntin to the exterior surface of the daylight opening of the VIG panel.

12. The window structure of claim 2 wherein
the left vertical member of the window frame comprises a glazing pocket, said glazing pocket being an aperture running from an inner edge of the left vertical member into an interior of the left vertical member at a uniform depth,
the right vertical member of the window frame comprises a glazing pocket, said glazing pocket being an aperture running from an inner edge of the right vertical member into an interior of the right vertical member at a uniform depth,
the top horizontal member of the window frame comprises a glazing pocket, said glazing pocket being an aperture running from an inner edge of the top horizontal member into an interior of the top horizontal member at a uniform depth,
the bottom horizontal member of the window frame comprises a glazing pocket, said glazing pocket being an aperture running from an inner edge of the bottom horizontal member into an interior of the bottom horizontal member at a uniform depth;
whereby the left edge of the perimeter edge of the VIG panel is dimensioned to be fully inserted into the glazing pocket of the left vertical member of the window frame, the right edge of the perimeter edge of the VIG panel is dimensioned to be fully inserted into the glazing pocket of the right vertical member of the window frame, the top edge of the perimeter edge of the VIG panel is dimensioned to be fully inserted into the glazing pocket of the top horizontal member of the window frame, and the bottom edge of the perimeter edge of the VIG panel is dimensioned to be fully inserted into the glazing pocket of the bottom horizontal member of the window frame.

13. The window structure of claim 12 further comprising
an interior muntin and
an exterior muntin,
wherein the interior muntin is dimensioned to fit onto the daylight opening of the VIG panel, and
the exterior muntin is dimensioned to fit onto the daylight opening of the VIG panel;
whereby the interior muntin is affixed to an interior surface of the daylight opening of the VIG panel, and
the exterior muntin is affixed to an exterior surface of the daylight opening of the VIG panel.

14. The window structure of claim 13 wherein
the interior muntin extends inward from the interior surface of the daylight opening of the VIG panel in a substantially perpendicular orientation thereto, and
the exterior muntin extends outward from the exterior surface of the daylight opening of the VIG panel in a substantially perpendicular orientation thereto.

15. The window structure of claim 14 wherein
the interior muntin has a width and the exterior muntin had a width, with the width of the interior muntin being substantially the same as the width of the exterior muntin.

16. The window structure of claim 15 wherein
the width of the interior muntin ranges from ½ inch to 2¼ inches, and
the width of the exterior muntin ranges from ½ inch to 2¼ inches.

17. The window structure of claim 14 wherein
the interior muntin has a first lateral side and a second lateral side, and
the exterior muntin has a first lateral side and a second lateral side,
with the first lateral side of the interior muntin being shaped by a series of straight lines and curves,
the second lateral side of the interior muntin being shaped by a series of straight lines and curves in a mirror image design of the first lateral side of the interior muntin,
the first lateral side of the exterior muntin being angled outwardly to the exterior surface of the daylight opening of the VIG panel, and
the second lateral side of the exterior muntin being angled outwardly to the exterior surface of the daylight opening of the VIG panel.

18. The window structure of claim 12 wherein
the glazing pocket of the left vertical member of the window frame comprises a thermally insulating material,
the glazing pocket of the right vertical member of the window frame comprises a thermally insulating material,
the glazing pocket of the top horizontal member of the window frame comprises a thermally insulating material, and
the glazing pocket of the bottom horizontal member of the window frame comprises a thermally insulating material.

19. The window structure of claim 18 wherein
the thermally insulating material is comprised of the group of polyurethane foam and polystyrene foam.

20. The window structure of claim 3 further wherein
the interior muntin is affixed to an interior surface of the daylight opening of the VIG panel by the use of very high bond double sided tape, and
the exterior muntin is affixed to an exterior surface of the daylight opening of the VIG panel by the use of very high bond double sided tape.

21. The window structure of claim 13 further wherein
the interior muntin is affixed to an interior surface of the daylight opening of the VIG panel by the use of very high bond double sided tape, and
the exterior muntin is affixed to an exterior surface of the daylight opening of the VIG panel by the use of very high bond double sided tape.

22. The window structure of claim 12 wherein
the depth of the glazing pocket of the left vertical member of the window frame is between 2 inches and 3 inches,
the depth of the glazing pocket of the right vertical member of the window frame is between 2 inches and 3 inches,
the depth of the glazing pocket of the top horizontal member of the window frame is between 2 inches and 3 inches, and
the depth of the glazing pocket of the bottom horizontal member of the window frame is between 2 inches and 3 inches.

23. The window structure according to any of the preceding claims, wherein
the window frame is integrated with a door.
